(19) United States
(12) Patent Application Publication
(10) Pub. No.: US 2011/0127909 A1
(43) Pub. Date: Jun. 2, 2011

(54) PLASMA PANEL AND PLASMA DISPLAY APPARATUS

(75) Inventors: Tae-soon PARK, Hwaseong-si (KR); Young-ki SHON, Hwaseong-si (KR); Sung-hwan LIM, Uiwang-si (KR)

(73) Assignee: SAMSUNG ELECTRONICS CO., LTD., Suwon-si (KR)

(21) Appl. No.: 12/938,526

(22) Filed: Nov. 3, 2010

(30) Foreign Application Priority Data
Nov. 27, 2009 (KR) 10-2009-0115908

(51) Int. Cl. H01J 17/49; B05D 5/06

(52) U.S. Cl. 313/582; 427/64

(57) ABSTRACT

A plasma panel, a plasma display apparatus, and a method of forming a complex functional layer for the plasma panel are provided, the plasma panel including: a front glass substrate and a back glass substrate which form a plurality of discharge cells; and a complex functional layer which is formed on an external surface of the front glass substrate. The complex functional layer includes a base substance, an optical functional substance, and a polymer substance to improve a crashworthy property of the front glass substrate.

### CROSS-REFERENCE TO RELATED APPLICATIONS

This application claims priority from Korean Patent Application No. 10-2009-0115908, filed on Nov. 27, 2009 in the Korean Intellectual Property Office, the disclosure of which is incorporated herein by reference in its entirety.

### BACKGROUND

1. Field

Apparatuses and methods consistent with the exemplary embodiments relate to a plasma panel and a plasma display apparatus, and more particularly, to a plasma panel including a complex functional layer formed at a front glass substrate, and a plasma display apparatus having the same.

2. Description of the Related Art

Plasma display apparatuses, usually called plasma display panels (PDPs), are representative flat panel displays together with liquid crystal displays (LCDs).

A plasma display apparatus includes a plasma panel, called a PDP panel or a PDP module. The plasma panel realizes an image by a fluorescent substance using gas discharge to emit light. For the gas discharge, a high voltage is used. Accordingly, in general, plasma display apparatuses are provide with a glass filter to shield electromagnetic interference (EMI). The glass filter is disposed in front of a plasma panel, and various functional films are formed on the external surface of the glass filter.

Recently, plasma display apparatuses which do not need the glass filter by reducing generation of the EMI at a circuit level have been developed. In such a new type of plasma display apparatus, a functional dye or pigment coated on a glass substrate of a plasma panel can replace the functions of functional films formed on a glass filter.

In the new type of plasma display apparatus, however, one side of the plasma panel is externally exposed. Accordingly, there is a need for improving a crashworthy property of the plasma panel as well as a need for reducing scattering of fragments of glass when the plasma panel is damaged by external impact.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

Aspects of the exemplary embodiments provide a plasma panel which has an improved crashworthy property and can reduce scattering of fragments of glass upon damage by external impact, and a plasma display apparatus having the same.

According to an aspect of an exemplary embodiment, there is provided a plasma panel, including: a front glass substrate and a back glass substrate which form a plurality of discharge cells; and a complex functional layer located on an external surface of the front glass substrate, wherein the complex functional layer includes a base substance, an optical functional substance, and a polymer substance to improve a crashworthy property of the front glass substrate.

The polymer substance may be urethane, epoxy, or ethylene propylene diene monomer (EPDM) rubber.

The base substance may be a silicate.

The optical functional substance may include at least one of an anti-reflection substance, a neon light cut (Ne-cut) substance, a near infrared light shielding substance, and an anti-glare substance.

The complex functional layer may be formed on the front glass substrate by spray coating or gravure coating.

According to an aspect of another exemplary embodiment, there is provided a plasma display apparatus, including: a plasma panel including a front glass substrate and a back glass substrate; and a casing which accommodates the plasma panel, wherein the front glass substrate includes a complex functional layer on an external surface thereof, and the complex functional layer includes a base substance, an optical functional substance, and a polymer substance to improve a crashworthy property of the front glass substrate.

The polymer substance may be urethane, epoxy, or EPDM rubber.

The base substance may be a silicate.

The optical functional substance may include at least one of an anti-reflection substance, a Ne-cut substance, a near infrared light shielding substance, and an anti-glare substance.

According to an aspect of another exemplary embodiment, there is provided a method of forming a complex functional layer for a plasma panel, the method including: providing a liquid mixture in which a base substance, an optical functional substance, and a polymer substance included in the complex functional layer are mixed with an organic solvent; and coating a front glass substrate of the plasma panel with the liquid mixture.

The coating of the front glass substrate of the plasma panel with the liquid mixture may include spray-coating or gravure-coating.

The polymer substance may be urethane, epoxy, or EPDM rubber.

The organic solvent may be acetone or alcohol.

According to an aspect of another exemplary embodiment, there is provided a display panel for a display apparatus, the display panel including: a front glass substrate to display an image; and a complex functional layer adhered to an external surface of the front glass substrate and exposed to an outside of the display apparatus, wherein the complex functional layer comprises a ductile substance to improve a crashworthy property of the front glass substrate.

### BRIEF DESCRIPTION OF THE DRAWINGS

The above and/or other aspects will be more apparent by describing certain exemplary embodiments with reference to the accompanying drawings, in which:

FIG. 1 is a schematic exploded perspective view of a plasma display apparatus according to an exemplary embodiment; and

FIG. 2 is a partially expanded view of the plasma panel of the

### DETAILED DESCRIPTION OF EXEMPLARY EMBODIMENTS

Certain exemplary embodiments will now be described in greater detail with reference to the accompanying drawings. In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the invention with unnecessary detail. Furthermore, expressions such as “at least one of,” when preceding a list of elements, modify the entire list of elements and do not modify the individual elements of the list.

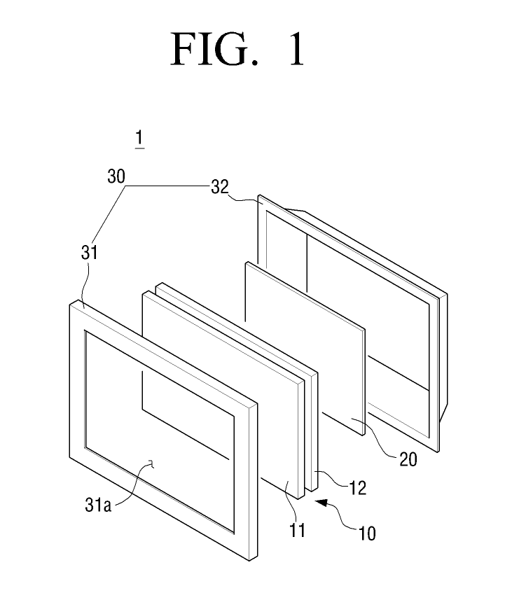

FIG. 1 is a schematic exploded perspective view of a plasma display apparatus 1 according to an exemplary embodiment. Referring to FIG. 1, the plasma display apparatus 1 may include a plasma panel 10, a driving substrate 20, and a casing 30.

The plasma panel 10 may include a pair of substrates, i.e., a front glass substrate 11 and a back glass substrate 12. Discharge cells (not shown) corresponding to pixels are interposed between the front glass substrate 11 and the back glass substrate 12. In each discharge cell, ultraviolet light is emitted toward a fluorescent substance by gas discharge such that the fluorescent substance emits visible light.

The driving substrate 20 is disposed behind the plasma panel 10 so as to drive and control the plasma panel 10.

The casing 30 accommodates a plurality of components of the plasma display apparatus 1 including the plasma panel 10 and the driving substrate 20. The casing 30 may include a front casing 31 and a back casing 32 which are detachably connected to each other. The front casing 31 has an opening 31a of a rectangular shape so as to expose the screen of the plasma panel 10.

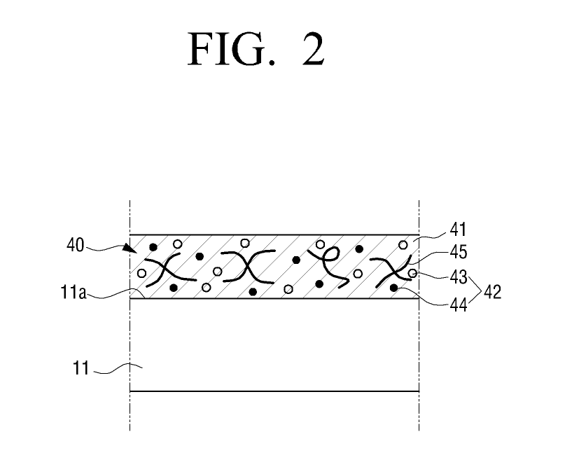

FIG. 2 is a partially expanded view of the plasma panel 10 of the plasma display apparatus 1 illustrated in FIG. 1. Referring to FIG. 2, a complex functional layer 40 is arranged at the external surface 11 a of the front glass substrate 11.

The complex functional layer 40 may include a base substance 41, an optical functional substance 42, and a polymer substance 45.

The base substance 41 may be implemented as a silicate, which is the raw material for making glass. The silicate is optically transparent, so even if the silicate is arranged at the front glass substrate 11, the silicate does not affect visible light generated by the plasma panel 10. In addition, the silicate and the front glass substrate 11 are chemically similar, so the silicate can easily adhere to the front glass substrate 11. The optical functional substance 42 and the polymer substance 45 are mixed with the base substance 41 having good adherence to the front glass substrate 11, and thus are prevented from being separated from the front glass substrate 11. Accordingly, the lifespan of the complex functional layer 40 increases. While in the present exemplary embodiment, the silicate is used as the base substance 41, it is understood that other substances which are optically transparent and have good adherence to the front glass substrate 11 may be used in another exemplary embodiment.

The optical functional substance 42 is evenly distributed in the base substance 41 so as to improve image quality. The optical functional substance 42 may include an anti-reflection substance 43 for reducing reflection of externally incident light, and a neon light cut (Ne-cut) substance 44 having a Ne-cut function. While in the present exemplary embodiment, the optical functional substance 42 includes the anti-reflection substance 43 and the Ne-cut substance 44, it is understood that another exemplary embodiment is not limited thereto. For example, in another exemplary embodiment, the optical functional substance 42 may include at least one of a near infrared light shielding substance for shielding near infrared light and an anti-glare substance for anti-glare.

The polymer substance 45 is evenly distributed in the base substance 41 so as to improve ductility of the complex functional layer 40. For example, the polymer substance 45 may be implemented as urethane. That is, since urethane has high ductility, the complex functional layer 40 including urethane has high ductility. In addition, urethane is optically transparent and thus does not affect visible light generated by the plasma panel 10. While in the present exemplary embodiment, urethane is used as the polymer substance 45, it is understood that in another exemplary embodiment, other optically transparent polymer substances having high ductility, such as epoxy and EPDM (ethylene propylene diene monomer) rubber, may be used.

The polymer substance 45 is included in the complex functional layer 40, so a crashworthy property of the complex functional layer 40 can be improved, and a crashworthy property of the front glass substrate 11 and the back glass substrate 12 can be enhanced. Therefore, even if the plasma panel 10 receives an external shock, the risk of damaging the plasma panel 10 is reduced as compared to a related art plasma panel.

Furthermore, when the glass substrates 11 and 12 are damaged by external shock, the polymer substance 45 having high ductility holds the damaged glass substrates 11 and 12. Accordingly, scattering of fragments of glass can be highly reduced, so the risk of hurting a user upon damage by external shock can be reduced.

A method of manufacturing the complex functional layer 40 is as follows. A coatable liquid mixture is formed by mixing the base substance 41 (e.g., silicate), the optical functional substance 42 (e.g., including the anti-reflection substance 43 and the Ne-cut substance 44), and the polymer substance 45 (e.g., urethane) in an organic solvent (e.g., acetone). The external surface 11a of the front glass substrate 11 is spray-coated or gravure-coated with the mixture. Subsequently, the organic solvent volatilizes from the mixture, so the complex functional layer 40 which includes the base substance 41, the optical functional substance 42, and the polymer substance 45 is located on the external surface 11a of the front glass substrate 11. While in the present exemplary embodiment, acetone is provided as an example of an organic solvent, it is possible to use other substances having volatility, such as alcohol, in another exemplary embodiment.

In addition, unlike the present exemplary embodiment, instead of mixing the polymer substance 45 in the complex functional layer 40, a protective film such as a polyethylene terephthalate film (PET) may be attached onto the complex functional layer 40 of the plasma panel 10 in another exemplary embodiment. Such a protective film can perform the same function as the polymer substance 45. That is, the protective film can contribute to improvement in a crashworthy property of the plasma panel 10 and prevention of scattering of fragments of glass. This method includes additional processes of preparing and bonding the protective film. In the present exemplary embodiment, the complex functional layer 40 is formed by coating the front glass substrate 11 with a liquid mixture one time, so the additional processes of preparing and bonding the protective film are not needed.

As can be appreciated from the above description of the plasma display apparatus 1 according to an exemplary embodiment, the complex functional layer 40 including the optical functional substance 42 and the polymer substance 45 is arranged on the front glass substrate 11 of the plasma panel 10. Therefore, a crashworthy property of the plasma panel 10 can be improved and scattering of fragments of glass upon damage can be reduced as compared to a related art plasma panel, so the security of use can be increased. Furthermore, the complex functional layer 40 is applied by one time coating, so the manufacturing process and cost of the plasma panel 10 can be reduced.

The foregoing exemplary embodiments are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A plasma panel, comprising:
a front glass substrate and a back glass substrate which form a plurality of discharge cells to display an image; and
a layer located on an external surface of the front glass substrate,
wherein the layer comprises a base substance, an optical substance distributed in the base substance to improve a quality of the image, and a polymer substance distributed in the base substance to improve a crashworthy property of the front glass substrate.

2. The plasma panel according to claim 1, wherein the polymer substance is urethane, epoxy, or ethylene propylene diene monomer (EPDM) rubber.

3. The plasma panel according to claim 1, wherein the base substance is a silicate.

4. The plasma panel according to claim 1, wherein the optical substance comprises at least one of an anti-reflection substance to reduce reflection of externally incident light on the front glass substrate, a neon light cut (Ne-cut) substance, a near infrared light shielding substance, and an anti-glare substance.

5. The plasma panel according to claim 1, wherein the layer is formed on the front glass substrate by spray coating or gravure coating.

6. The plasma panel according to claim 1, wherein the base substance is an optically transparent substance.

7. A plasma display apparatus, comprising:
a plasma panel comprising a front glass substrate and a back glass substrate which form a plurality of discharge cells to display an image; and
a casing which accommodates the plasma panel,
wherein the front glass substrate comprises a layer on an external surface of the front glass substrate, and the layer comprises a base substance, an optical substance distributed in the base substance to improve a quality of the image, and a polymer substance distributed in the base substance to improve a crashworthy property of the front glass substrate.

8. The plasma display apparatus according to claim 7, wherein the polymer substance is urethane, epoxy, or ethylene propylene diene monomer (EPDM) rubber.

9. The plasma display apparatus according to claim 7, wherein the base substance is a silicate.

10. The plasma display apparatus according to claim 7, wherein the optical substance comprises at least one of an anti-reflection substance to reduce reflection of externally incident light on the front glass substrate, a neon light cut (Ne-cut) substance, a near infrared light shielding substance, and an anti-glare substance.

11. The plasma display apparatus according to claim 7, wherein the casing comprises an opening corresponding to the front glass substrate such that the layer is exposed to an outside.

12. A method of forming a layer for a plasma panel, the method comprising:
providing a liquid mixture in which a base substance, an optical functional substance, and a polymer substance included in the layer are mixed with an organic solvent; and
coating a front glass substrate of the plasma panel with the liquid mixture.

13. The method according to claim 12, wherein the coating the front glass substrate of the plasma panel with the liquid mixture comprises spray-coating or gravure-coating the front glass substrate of the plasma panel with the liquid mixture.

14. The method according to claim 12, wherein the polymer substance is urethane, epoxy, or ethylene propylene diene monomer (EPDM) rubber.

15. The method according to claim 12, wherein the organic solvent is acetone or alcohol.

16. A display panel for a display apparatus, the display panel comprising:
a front glass substrate to display an image; and
a layer adhered to an external surface of the front glass substrate and exposed to an outside of the display apparatus,
wherein the layer comprises a ductile substance to improve a crashworthy property of the front glass substrate.

17. The display panel according to claim 16, wherein:
the layer further comprises a base substance; and
the ductile substance is a polymer substance distributed in the base substance to improve the crashworthy property of the front glass substrate.

18. The display panel according to claim 16, wherein:
the layer further comprises a base substance and an optical substance distributed in the base substance to improve a quality of the image.
